(19) United States
(12) Patent Application Publication
(10) Pub. No.: US 2013/0209802 A1
(43) Pub. Date: Aug. 15, 2013

(54) THERMOSETTING RESIN COMPOSITION, CURED MATERIAL, CONDUCTIVE WIRE, COIL FOR ELECTRICAL DEVICE, AND ELECTRICAL DEVICE

(71) Applicant: Hitachi, Ltd., (US)

(72) Inventors: Takahito MURAKI, Hitachinaka (JP); Satoru AMOU, Hitachi (JP); Hiroyuki KAGAWA, Hitachinaka (JP)

(73) Assignee: HITACHI, LTD., Tokyo (JP)

(21) Appl. No.: 13/764,849

(22) Filed: Feb. 12, 2013

(30) Foreign Application Priority Data
Feb. 15, 2012 (JP) 2012-030083

(51) Int. Cl. H01B 3/30

(52) U.S. Cl. CPC H01B 3/30
USPC 428/370; 526/258; 526/271; 428/394

(57) ABSTRACT

An object of the present invention is to provide a resin composition showing high heat resistance even in low-temperature curing and an electrical device using the resin composition. The object is solved by a thermosetting resin composition comprising (A) a compound of an oligomer having two or more of radical-polymerizable substituent X of which binding energy of repeated structure is higher than binding energy of carbon-carbon formed by the substituent X; (B) a compound having a polymerizable substituent highly reactive with the substituent X; and (C) a polymerization initiator.

### CROSS-REFERENCE TO RELATED APPLICATION

The present application claims priority from Japanese Patent Application No. 2012-030083 filed on Feb. 15, 2012, the content of which is hereby incorporated by reference into this application.

### TECHNICAL FIELD OF THE INVENTION

The present invention relates to a thermosetting resin composition having excellent heat resistance even in low-temperature curing, particularly, suitable for the electrical insulation, fixing, or molding of an electrical device such as motors.

### BACKGROUND OF THE INVENTION

An electrical device coil of a rotating machine, such as a motor, is treated with a resin composition for the purpose of electrical insulation, heat dissipation during operation, the absorption of roaring sound due to electrical oscillation, the fixing of constituent materials, etc. As a resin composition capable of performing the functions, a thermoplastic resin material such as polyetherimide, polyetheretherketone, and polyphenylene sulfide, and a thermosetting resin material such as unsaturated polyester resins and epoxy resins, have been mainly used.

A static device such as a transformer or a breaker is also partially mold-treated with a thermosetting resin composition for the purpose of electrical insulation, ensuring a safety in a fire, and noise reduction. As a thermosetting resin material capable of performing the functions, unsaturated polyester resins, epoxy resins, and the like have been mainly used.

It has been demanded better heat resistance for downsizing and higher powering recent electrical devices. It has been therefore also demanded resins with a higher level of heat resistance for use in an electrical device such as resins for fixing a rotating machine coil or molding a transformer. Meanwhile, in terms of energy saving or cost reduction of manufacture processes, a decrease of process temperature has been demanded.

However, in the conventional design concept for highly heat-resistant resins, the enhancement of heat resistance requires an increase of process temperature, and thus it has been difficult to fully satisfy the above demands.

In order to solve the above problems, JP 2005-162906 discloses a resin composition comprising (A) an unsaturated polyester having an acid number of 40 or less obtained by a reaction of dicyclopentadienyl monomaleate, unsaturated dibasic acid, saturated dibasic acid, and an alcohol component, (B) an unsaturated polyester having an acid number of 40 or less obtained by a reaction of diaminodiphenylmethane, unsaturated polybasic acid, saturated polybasic acid, and an alcohol component, (C) a cross-linkable monomer, and (D) an organic peroxide. JP 2009-67934 discloses that a sulfone-group-containing polyhydroxy polyether resin and bismaleimide are used.

Heat resistance is based on the level of thermal decomposition temperature or glass transition temperature. Generally, the heat resistance of a thermoplastic resin depends on the melting point thereof.

### SUMMARY OF THE INVENTION

It is not recognized that sufficient heat resistance has been obtained in JP 2005-162906 or JP 2009-67934. A purpose of the present invention is to provide a resin composition performing high heat resistance even in a low-temperature process and an electrical device with the resin composition.

The thermosetting resin composition of the present invention comprises (A) a compound of an oligomer having two or more of radical-polymerizable substituent X of which binding energy of repeated structure is higher than binding energy of carbon-carbon formed by the substituent X; (B) a compound having a polymerizable substituent highly reactive with the substituent X; and (C) a polymerization initiator.

The resin composition of the present invention shows high heat resistance even in a low-temperature process.

### BRIEF DESCRIPTIONS OF THE DRAWINGS

FIG. 1 schematically shows a coil for an electrical device insulated using the thermosetting resin composition of the present invention; and

FIG. 2 schematically shows an example of an electrical device.

### DESCRIPTIONS OF THE PREFERRED EMBODIMENTS

The inventors have conducted extensive research to solve the above problems and found that a thermosetting resin composition comprising (A) a compound of an oligomer having two or more of radical-polymerizable substituent X of which binding energy of repeated structure is higher than binding energy of carbon-carbon formed by the substituent X; (B) a compound having a polymerizable substituent highly reactive with the substituent X; and (C) a polymerization initiator is preferable.

When a low-molecular-weight material is used, it is easily produced a volatile decomposition product during the thermal decomposition and it leads to decrease the thermal decomposition temperature. Moreover, when a compound with high-molecular-weight is used, a volatile decomposition product is less produced during thermal decomposition. However, since the movement of the reactive site is suppressed, the reaction may not be completed. Therefore, considered reactivity, a material with low molecular weight is applied in the present invention.

The present invention is described in detail hereinafter.

### [Component (A)]

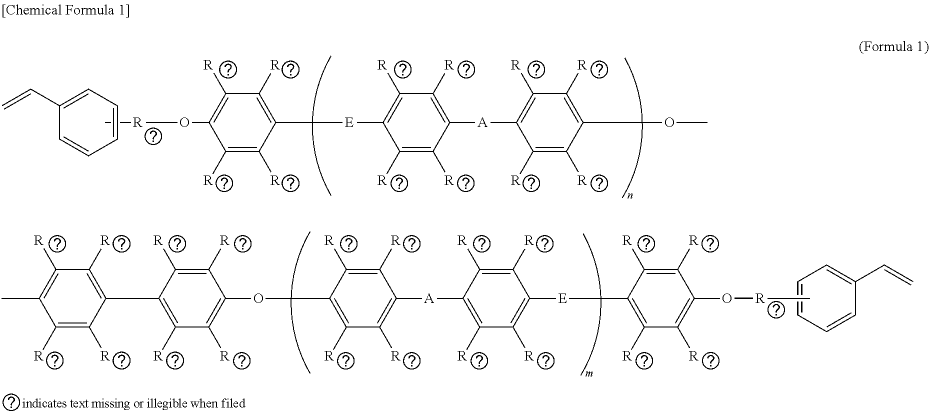

This is a compound having the structure shown in Formula 1. Each of R₁ to R₃₂ is a hydrogen atom or a hydrocarbon group having 1 to 9 carbon atom(s), and each of R₃₃ and R₃₄ is an organic group having 1 or more carbon atom(s). Each of A and E in Formula 1 is independently oxygen, sulfur, sulfoxide group, sulfone group, carbonyl group, amino group, or alkylated amino group. n is the degree of polymerization shown by an integer of 1 or more. Specifically, it includes a polyphenylene ether derivative wherein each of R_{10,}

R₁₂, R₁₄, R₁₆, R₁₈, R₂₀, R₂₂, R₂₄, R₂₆, R₂₈, R₃₀, and R₃₂ is a methyl group and each of remaining Rs among R₁ to R₃₂ is a hydrogen atom, each of R₃₃ and R₃₄ is a methylene group, and each of A and E is an oxygen atom; a polyphenylene sulfide derivative wherein each of R₁ to R₃₂ is a hydrogen atom, each of R₃₃ and R₃₄ is a methylene group, and each of A and E is a sulfur atom; a polyetheretherketone derivative wherein each of R₁ to R₃₂ is a hydrogen atom, each of R₃₃ and R₃₄ is a methylene group, A is an oxygen atom, and E is carbonyl group; and a polyethersulfone derivative wherein each of R₁ to R₃₂ is a hydrogen atom, each of R₃₃ and R₃₄ is a methylene group, A is an oxygen atom, and E is sulfone group and so on. It is not limited if binding energy of repeated structure is higher than binding energy of carbon-carbon (347 kJ/mol) generated by a radical reaction. In terms of melting temperature, it is preferable that n and m show a polymerization degree of which the molecular weight corresponds to 1000 to 5000 of the styrene-equivalent molecular weight.

Among them, polyphenylene, ether derivative and a polyphenylene sulfide derivative are preferable in terms that compatibility of both solubility and heat resistance is achieved.

### [Component (B)]

A compound (B) with a polymerizable substituent highly reactive with the substituent X includes a group of compounds represented by Formula 2.

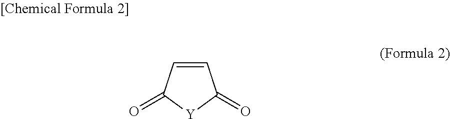

The substituent Y includes an oxygen atom, a sulfur atom, and a substituted nitrogen atom. Specifically, it includes maleimides such as maleic anhydride, thiomaleic anhydride, N-phenylmaleimide, N-naphthylmaleimide, N-methylphenylmaleimide, N-methoxyphenymaleimide, N-chloromaleimide, N-methylmaleimide, N-ethylmaleimide, N-propylmaleimide, N-butylmaleimide, and N-isopropylmaleimide and so on; bismaleimides such as bisphenol A diphenyl ether bismaleimide, 3,3′-dimethyl-5,5′-diethyl-4,4′-diphenylmethane bismaleimide, butylene bismaleimide, methylene bismaleimide, ethylene bismaleimide, and maleimide-terminated polyimide resins and so on; and polymaleimides such as poly(phenylmethane maleimide), maleimide derivatives of PAMAM dendrimers, maleimide derivatives of (2-aminoethyl)polystyrene and so on.

Among them, bismaleimides and polymaleimides are preferable in terms of stability after curing and heat resistance. Maleimide-terminated polyimide resins are more preferable in terms of reactivity, thermostability and flexibility.

The weight ratio of the component (A) to the component (B), (A)/(B) is preferably 70/30 to 10/90, and more preferably 50/50 to 10/90. The weight ratio of the component (A) which is out of this range is not desirable because the curing reaction does not proceed smoothly, resulting in poor air-drying properties.

### [Component (C)]

The polymerization initiator (C) may be at least one selected from the group consisting of organic peroxides, organic azo compounds, boron compounds represented by the following Formula 3, and alkoxyamine derivatives represented by the following Formula 4.

An organic peroxide includes, but not limited to, benzoyl peroxide, lauroyl peroxide, t-butyl peroxybenzoate, t-amyl peroxybenzoate, t-amyl peroxyneodecanoate, t-butyl peroxyneodecanoate, t-amyl peroxyisobutyrate, di-t-butyl peroxide, dicumyl peroxide, cumene hydroperoxide, 1,1-di(t-butylperoxy)cyclohexane, 2,2-di(t-butylperoxy)butane, t-butyl hydroperoxide, di(s-butyl)peroxycarbonate, and methyl ethyl ketone peroxide and so on. These may be used singly or in combination with two or more.

An organic azo compound includes, but not limited to, 2,2′-azobis(2 4-dimethylvaleronitrile), 2,2′-azobis(2-methyl propionitrile), 1,1′-azobis(cyclohexane-1-carbonitrile), 2,2′-azobis [N-(2-propenyl)-2-methylpropionamide], and dimethyl-2,2′-azobis(2-methylpropionate) and so on. These may be used singly or in combination with two or more.

When a boron compound represented by the following Formula 3 or alkoxylamine derivative represented by the following Formula 4 is used, since living polymerization proceeds, further improvement of heat resistance is achieved.

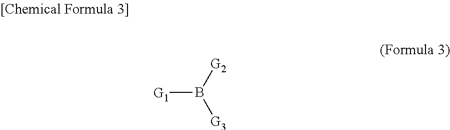

(In Formula 3, each of G₁, G₂, and G₃ is independently R₁ or OR₁ (at least one of G₁, G₂, and G₃ is R₁), and R₁ is hydrogen, alkyl group, cycloalkyl group, aralkyl group, or aryl group.)

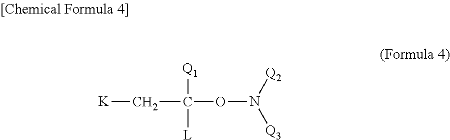

(In Formula 4, Q₂ is hydrogen or alkyl group, each of Q₃ and Q₄ is independently alkyl group, cycloalkyl group, or alkylene group, L is alkyl group, cycloalkyl group, aryl group, or alkoxycarbonyl group, and K is alkyl group, cycloalkyl group, aryl group, alkoxyl group, or acyloxy group.)

A boron compound includes triethylboron, tripropylboron, triisopropylboron, tri-n-butylboron, tri-n-amylboron, tri-n-hexylboron, tricyclohexylboron, 9-borabicyclo[3.3.1]nonane, isopinocampheylboron and so on, and boron compound oxides obtained by partial oxidation thereof and so on. Since the boron compounds generate a radical with oxygen, the reaction is carried out in the air.

Alkoxyamine derivatives are not limited, and may be synthesized from an N-oxyls and an ethylenic unsaturated monomer under the presence of a radical-generating reagent.

The radical-generating reagent used for the above reaction includes, but not limited to, a peroxide such as benzoyl peroxide, lauroyl peroxide, t-butyl hydroperoxide, cumene hydroperoxide, and di-t-butyl peroxide and so on and an azobis radical-generating reagent such as 2,2′-azobis(isobutyronitrile), 1,1′-azobis(cyclohexanecarbonitrile), 4,4′-azobis(4-cyanovaleric acid), and 2,2′-azobis(2-methylpropione amidine)dihydrochloride and so on.

N-oxyls used for the above reaction include, but not limited to, 1-oxyl-2,2,6,6-tetramethylpiperidine, 1-oxyl-2,2,6,6-tetramethylpiperidin-4-ol, and 4-methoxy-2,2,6,6-tetramethylpiperidin-l-oxyl and so on. These N-oxyls may be used singly or in combination with two or more.

The amount of the polymerization initiator (C) is preferably 0.2 wt % or more and 5.0 wt % or less to the total weight of the components (A) and (B). When the amount is less than 0.2 wt %, since curing is not completed, desired characteristics are not obtained. Meanwhile, an amount of more than 5.0 wt % leads to poor storage stability and thus is undesirable.

Hundred parts by weight or more of inorganic fine particles (D) may be added to 100 parts by weight of a resin composition made of the component (A), the component (B), and the component (C) to obtain a thermosetting resin composition. The inorganic fine particle of the component (D) may be suitably selected and added according to the required characteristics as a cured resin. This has advantages in that the linear expansion coefficient can be matched with a substrate to be molded using the resin, flame retardancy can be imparted, thermal conductivity can be improved, etc. A fine particle used includes, but not limited to, silica, talc, calcium carbonate, magnesium oxide, aluminum hydroxide, aluminum oxide, boron nitride, mica, titanium oxide, and zinc oxide and so on. These inorganic fine particles may be used singly or in combination with two or more.

### [Other Optional Components]

In the thermosetting resin composition of the present invention (hereinafter referred to as the composition of the invention) a solvent for facilitating mixing may be optionally added, if necessary. The solvent includes tetrahydrofuran, toluene, methyl ethyl ketone, and acetone and so on. Considered the residual solvent at curing, preferable boiling point of the solvent is 120° C. or less. These may be used singly or in combination with two or more.

As a solvent, a reactive diluent such as styrene, methyl methacrylate, or a (meth)acrylate made of a secondary alcohol or tertiary alcohol having a bicyclo or tricyclo structure may be used. A curing accelerator may be added to accelerate curing. A curing accelerator includes a metal salt of naphthenic acid or octylic acid (metal salts such as cobalt, zinc, zirconium, manganese, calcium, etc.). These may be used singly or in combination with two or more.

As an adhesion-improving auxiliary agent, a coupling agent such as vinyltrimethoxysilane, styryltriethoxysilane and so on, or an isocyanate such as 2-(1′[2,4-dimethylpyrazolyl]carboxyamino)ethyl methacrylate of which an isocyanate or isocyanate group having a vinyl group and one isocyanate group to the terminal of 2-methacryloyloxyethyl isocyanate has heat latency may be added. These may be used singly or in combination with two or more. Furthermore, a polymerization inhibitor may be incorporated. The polymerization inhibitor includes quinones such as hydroquinone, p-tert-butylcatechol, and pyrogallol and so on, if necessary. These may be used singly or in combination with two or more.

### [Method for Producing the Composition of the Invention]

As a method for producing the composition of the invention, the component (A), the component (B), and other optional components are uniformly stirred and mixed at room temperature (25° C.) or with heating. The range of heating temperature is preferably 40 to 80° C. and depends on the viscosities and the melting points of the component (A) and the component (B). A stirrer may be used for stirring and mixing, if necessary.

After producing a mixture of the component (A) and the component (B), the component (C) is added at room temperature (25° C.), followed by uniform mixing.

As a method for curing the composition of the invention, it is preferable to cure the composition of the invention at 120 to 180° C. for 1 to 3 hours. The curing temperature is suitably adjusted according to the intended use.

As an alternative method, it is also possible that the above component (A), component (B), and other optional components may be melt-kneaded, and then the component (C) may be added again, followed by uniform mixing.

When the composition of the invention is used for a motor coil or the like, for example, an electrical device such as a motor coil is impregnated with this composition by a dip coating method, a dropping impregnation method, etc. The impregnation method may be a conventional method and not limited.

The composition of the invention may be applied to the electrical insulation or fixing of a coil for an electrical device such as a motor, or for the molding of a coil. The molding method may be a conventional method such as vacuum casting, press casting, or transfer molding, but not limited to.

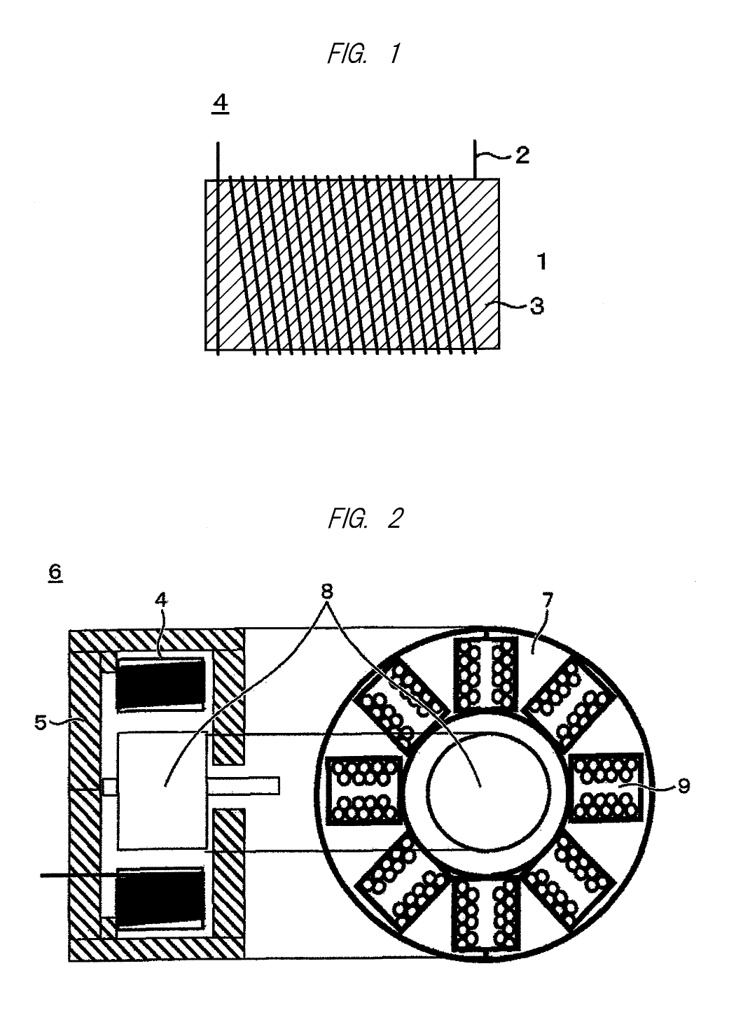

Hereinafter, a coil for an electrical device insulated using the composition of the invention is described with figures. FIG. 1 schematically shows a coil for an electrical device insulated using the composition of the invention. FIG. 2 schematically shows the configuration of a dynamo-electric machine as an example of an electrical device.

As shown in FIG. 1, a stator coil 4 is produced by twisting an enamel wire (coated conductive wire) 2 around a magnetic core 1 of a metal such as iron. The stator coil 4 is applied the composition of the invention by dip coating method, dropping impregnation method, etc. Subsequently, the composition of the invention is cured by heating under the predetermined temperature and time to form a cured material 3, thereby giving a stator coil 4 insulated using the composition of the invention.

Alternatively, after the composition of the invention is applied to an enamel wire 2 and dried, the treated enamel wire 2 is twisted around a magnetic core 1 of a metal such as iron to produce a stator coil 4. Subsequently, the composition of the invention is cured by heating under the predetermined temperature and time to form a cured material 3, thereby giving a stator coil 4 insulated using the cured material 3.

As shown in FIG. 2, a dynamo-electric machine 6 consists of a housing 5, a cylindrical stator magnetic core 7, a rotor magnetic core 8 coaxially rolling inside the stator magnetic core 7, and a plurality of coils twisted an enamel wire 2 using a plurality of slots 9 formed in the axial direction in one or both of the stator magnetic core 7 and the rotor magnetic core 8. The composition of the invention is applied to the stator coil 4 by dip coating method, dropping impregnation method, etc. Subsequently, the composition is cured by heating under the predetermined temperature and time to obtain a stator insulated with the composition of the invention.

The stator and rotor are assembled by a conventional method, whereby the dynamo-electric machine 6 using the stator coil 4 insulated with the composition of the invention is obtained.

The present invention is described with the examples, but not limited to.

### EXAMPLE 1

Fifty parts by weight of a terminally styrene-modified polyphenylene ether derivative (Mitsubishi Gas Chemical, molecular weight: 2000, glass transition temperature: 110° C.) (hereinafter, the molecular weight and the glass transition temperature of the terminally styrene-modified polyphenylene ether derivatives in other examples and comparative examples are the same) and 50 parts by weight of N-phenylmaleimide (Sigma-Aldrich) were dissolved in 5 mL of tetrahydrofuran at room temperature to give a varnish. Two parts by weight of n-butyl 4,4-di(t-butylperoxy)butyrate (PERHEXA V manufactured by NOF Corporation) was added to 100 parts by weight of the varnish at room temperature to give a thermosetting resin composition.

The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was cut to a 5 mm length×5 mm width×0.5 mm thickness. Subsequently, the thermal weight loss temperature and the activation energy of decomposition were measured using a thermogravimetric analyzer Q500 manufactured by TA Instruments. The 5% weight loss temperature was determined by measuring temperatures from 40° C. to 600° C. increased at a rate of 10° C./min. The activation energy at 5% weight loss was determined by measuring temperatures from 40° C. to 600° C. increased at rates of 1° C./min, 3° C./min, and 5° C./min, respectively. Furthermore, after the cured material was cut to a 5 mm length×5 mm width×0.5 mm thickness, the glass transition temperature (Tg) was determined using a differential scanning calorimetry analyzer Q200 manufactured by TA Instruments. Measurement was performed in the air at a temperature from 30° C. to 200° C. increased at a rate of 10° C./min.

### EXAMPLE 2

Fifty parts by weight of a terminally styrene-modified polyphenylene ether derivative (Mitsubishi Gas Chemical) and 50 parts by weight of maleic anhydride (Sigma-Aldrich) were dissolved in 5 mL of tetrahydrofuran at room temperature to give a varnish. Two parts by weight of n-butyl 4,4-di(t-butylperoxy)butyrate (PERHEXA V manufactured by NOF Corporation) was added to 100 parts by weight of the varnish at room temperature to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 3

Fifty parts by weight of a terminally styrene-modified polyphenylene ether derivative (Mitsubishi Gas Chemical) and 50 parts by weight of BMI-4000 (Daiwa Chemical Industry) were dissolved in 10 mL of tetrahydrofuran at room temperature to give a varnish. Two parts by weight of n-butyl 4,4-di(t-butylperoxy)butyrate (PERHEXA V manufactured by NOF Corporation) was added to 100 parts by weight of the varnish at room temperature to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 4

Fifty parts by weight of a terminally styrene-modified polyphenylene ether derivative (Mitsubishi Gas Chemical) and 50 parts by weight of BMI-4000 (Daiwa Chemical Industry) were dissolved in 10 mL of tetrahydrofuran at room temperature to give a varnish. Two parts by weight of 1-[(1-cyano-1-methylethyl)azo]formamide (V-30 manufactured by Wako Pure Chemical Industries) was added to 100 parts by weight of the varnish at room temperature to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 5

Fifty parts by weight of a terminally styrene-modified polyphenylene ether derivative (Mitsubishi Gas Chemical) and 50 parts by weight of BMI-5000 (Designer Molecule) were dissolved in 5 mL of tetrahydrofuran at room temperature to give a varnish. Two parts by weight of n-butyl 4,4-di(t-butylperoxy)butyrate (PERHEXA V manufactured by NOF Corporation) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 6

Fifty parts by weight of a terminally styrene-modified polyphenylene ether derivative (Mitsubishi Gas Chemical) and 50 parts by weight of BMI-5000 (Designer Molecule) were dissolved in 5 mL of tetrahydrofuran at room temperature to give a varnish. Two parts by weight of 1-[(1-cyano-1-methylethyl)azo]formamide (V-30 manufactured by Wako Pure Chemical Industries) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 7

Fifty parts by weight of a terminally styrene-modified polyphenylene ether derivative (Mitsubishi Gas Chemical) and 50 parts by weight of BMI-5000 (Designer Molecule) were dissolved in 5 mL of tetrahydrofuran at room temperature to give a varnish. Two parts by weight of diethylmethoxyborane (Sigma-Aldrich) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 8

Fifty parts by weight of a terminally styrene-modified polyphenylene ether derivative (Mitsubishi Gas Chemical) and 50 parts by weight of BMI-5000 (Designer Molecule) were dissolved in 5 mL of tetrahydrofuran at room temperature to give a varnish. Two parts by weight of 9-BBN (Sigma-Aldrich) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 9

Fifty parts by weight of a terminally styrene-modified polyphenylene ether derivative (Mitsubishi Gas Chemical) and 50 parts by weight of BMI-5000 (Designer Molecule) were dissolved in 5 mL of tetrahydrofuran at room temperature to give a varnish. Two parts by weight of N-t-butyl-N-(2-methyl-1-phenylpropyl)-O-(1-phenylethyl)hydroxylamine (Sigma-Aldrich) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 10

Ten parts by weight of a terminally styrene-modified polyphenylene ether derivative (Mitsubishi Gas Chemical) and 90 parts by weight of BMI-5000 (Designer Molecule) were dissolved in 5 mL of tetrahydrofuran at room temperature to give a varnish. Two parts by weight of n-butyl 4,4-di(t-butylperoxy)butyrate (PERHEXA V manufactured by NOF Corporation) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 11

Ten parts by weight of a terminally styrene-modified polyphenylene sulfide derivative (molecular weight: 2500, glass transition temperature: 120° C.) and 90 parts by weight of BMI-5000 (Designer Molecule) were dissolved in 5 mL of tetrahydrofuran at room temperature to give a varnish. Two parts by weight of n-butyl 4,4-di(t-butylperoxy)butyrate (PERHEXA V manufactured by NOF Corporation) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### EXAMPLE 12

Fifty parts by weight of a terminally styrene-modified polyphenylene ether derivative (Mitsubishi Gas Chemical) and 50 parts by weight of a terminally maleimide-modified G2PAMAM derivative were dissolved in 5 mL of tetrahydrofuran at room temperature to give a varnish. 1 part by weight of n-butyl 4,4-di(t-butylperoxy)butyrate (PERHEXA V manufactured by NOF Corporation) and 1 part by weight of diethylmethoxyborane (Sigma-Aldrich) were added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

The results of Examples 1 to 12 are shown in Table 1 to Table 3. Tg is the glass transition temperature of a cured material, Td5 is the 5% weight loss temperature of a cured material, and Ea is the activation energy at the time of the thermal decomposition of a cured material.

TABLE 1

| | Example 1 | Example 2 | Example 3 | Example 4 |
|---|---|---|---|---|
| Component A | Terminally | Terminally | Terminally | Terminally |
| | styrene-modified | styrene-modified | styrene-modified | styrene-modified |
| | polyphenylene | polyphenylene | polyphenylene | polyphenylene |
| | ether derivative | ether derivative | ether derivative | ether derivative |
| | (50 parts by weight) | (50 parts by | (50 parts by | (50 parts by |
| | | weight) | weight) | weight) |
| Component B | N-phenylmaleimide | Maleic anhydride | BMI-4000 | BMI-4000 |
| | (50 parts by weight) | (50 parts by | (50 parts by | (50 parts by |
| | | weight) | weight) | weight) |
| Component C | PERHEXA V | PERHEXA V | PERHEXA V | V-30 |
| | (2 parts by weight) | (2 parts by | (2 parts by | (2 parts by |
| | | weight) | weight) | weight) |
| Tg | 165° C. | 163° C. | 170° C. | 170° C. |
| T_{D5} | 365° C. | 363° C. | 380° C. | 390° C. |
| Ea | 103 kJ/mol | 101 kJ/mol | 120 kJ/mol | 120 kJ/mol |

TABLE 2

| | Example 5 | Example 6 | Example 7 | Example 8 |
|---|---|---|---|---|
| Component A | Terminally | Terminally | Terminally | Terminally |
| | styrene-modified | styrene-modified | styrene-modified | styrene-modified |
| | polyphenylene | polyphenylene | polyphenylene | polyphenylene |
| | ether derivative | ether derivative | ether derivative | ether derivative |
| | (50 parts by weight) | (50 parts by | (50 parts by | (50 parts by |
| | | weight) | weight) | weight) |
| Component B | BMI-5000 | BMI-5000 | BMI-5000 | BMI-5000 |
| | (50 parts by weight) | (50 parts by | (50 parts by | (50 parts by |
| | | weight) | weight) | weight) |
| Component C | PERHEXA V | V-30 | Diethylmethoxyborane | 9-BBN |
| | (2 parts by weight) | (2 parts by | (2 parts by | (2 parts by |
| | | weight) | weight) | weight) |
| Tg | 160° C. | 160° C. | 165° C. | 165° C. |
| T_{D5} | 365° C. | 365° C. | 375° C. | 375° C. |
| Ea | 127 kJ/mol | 128 kJ/mol | 128 kJ/mol | 128 kJ/mol |

TABLE 3

| | Example 9 | Example 10 | Example 11 | Example 12 |
|---|---|---|---|---|
| Component A | Terminally | Terminally | Terminally | Terminally |
| | styrene-modified | styrene-modified | styrene-modified | styrene-modified |
| | polyphenylene | polyphenylene | polyphenylene | polyphenylene |
| | ether derivative | ether derivative | sulfide | ether derivative |
| | (50 parts by weight) | (10 parts by | derivative | (50 parts by |
| | | weight) | (10 parts by | weight) |
| | | | weight) | |
| Component B | BMI-5000 | BMI-5000 | BMI-5000 | Terminally |
| | (50 parts by weight) | (50 parts by | (50 parts by | maleimide-modified |
| | | weight) | weight) | G2PAMAM |
| | | | | derivative (50 |
| | | | | parts by weight) |
| Component C | N-t-butyl-N-(2-methyl- | PERHEXA V | PERHEXA V | PERHEXA V |
| | 1-phenylpropyl)- | (2 parts by | (2 parts by | (1 part by weight) + |
| | O-(1-phenylethyl)hydroxylamine | weight) | weight) | diethylmethoxyborane |
| | (2 | | | (1 part by |
| | parts by weight) | | | weight) |
| Tg | 167° C. | 160° C. | 160° C. | 160° C. |
| T_{D5} | 370° C. | 410° C. | 415° C. | 410° C. |
| Ea | 128 kJ/mol | 127 kJ/mol | 125 kJ/mol | 125 kJ/mol |

### EXAMPLE 13

Fifty parts by weight of a terminally styrene-modified polyphenylene ether derivative (Mitsubishi Gas Chemical) and 50 parts by weight of BMI-5000 (Designer Molecule) were dissolved in 5 mL of tetrahydrofuran at room temperature to give a varnish. Two parts by weight of n-butyl 4,4-di(t-butylperoxy)butyrate (PERHEXA V manufactured by NOF Corporation) and 200 parts by weight of spherical silica fine particles were mixed with 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The physical properties of the obtained cured material were as follows: Tg: 165° C., Td5 (as resin content): 360° C., Ea: 120 kJ/mol.

### COMPARATIVE EXAMPLE 1

Fifty parts by weight of a terminally styrene-modified polyphenylene ether derivative (Mitsubishi Gas Chemical) and 50 parts by weight of styrene (Wako Pure Chemical Industries) were mixed at room temperature to give a varnish. Two parts by weight of n-butyl 4,4-di(t-butylperoxy)butyrate (PERHEXA V manufactured by NOF Corporation) was added to 100 parts by weight of the varnish to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### COMPARATIVE EXAMPLE 2

Fifty parts by weight of vinyl ester (Sigma-Aldrich) and 50 parts by weight of styrene (Wako Pure Chemical Industries) were mixed at room temperature to give a varnish. Two parts by weight of n-butyl 4,4-di(t-butylperoxy)butyrate (PERHEXA V manufactured by NOF Corporation) was added to 100 parts by weight of the varnish at room temperature to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for physical properties.

### COMPARATIVE EXAMPLE 3

Fifty parts by weight of a liquid butadiene rubber B3000 and 50 parts by weight of styrene (Wako Pure Chemical Industries) were mixed at room temperature to give a varnish. Two parts by weight of n-butyl 4,4-di(t-butylperoxy)butyrate (PERHEXA V manufactured by NOF Corporation) was added to 100 parts by weight of the varnish at room temperature to give a thermosetting resin composition. The varnish was transferred to an aluminum case 40 mm in diameter and dried at room temperature overnight, followed by heating in a warm-air circulation thermostat preheated to 120° C. for 60 minutes and then heating at 160° C. for 60 minutes. The obtained cured material was processed in the same manner as in Example 1 and then measured for thermal decomposition temperature.

### COMPARATIVE EXAMPLE 4

Fifty parts by weight of a terminally styrene-modified polyphenylene ether derivative (Mitsubishi Gas Chemical) and 50 parts by weight of BMI-4000 (Daiwa

Chemical Industry) were mixed at room temperature. The varnish was transferred to an aluminum case 40 mm in diameter, followed by heating in a warm-air circulation thermostat preheated to 120° C. for 60 minutes and then heating at 160° C. for 60 minutes. However, no cured material was obtained. The results of Comparative Examples 1 to 4 are shown in Table 4. Tg is the glass transition temperature of a cured material, Td5 is the 5% weight loss temperature of a cured material, and Ea is the activation energy at the time of the thermal decomposition of a cured material.

TABLE 4

| | Comparative | Comparative | Comparative | Comparative |
|---|---|---|---|---|
| | Example 1 | Example 2 | Example 3 | Example 4 |
| Component A | Terminally | Vinyl ester | B3000 | Terminally |
| | styrene-modified | (50 parts by | (50 parts by | styrene-modified |
| | polyphenylene | weight) | weight) | polyphenylene |
| | ether derivative | | | ether derivative |
| | (50 parts by | | | (50 parts by |
| | weight) | | | weight) |
| Component B | Styrene | Styrene | Styrene | BMI-4000 |
| | (50 parts by | (50 parts by | (50 parts by | (50 parts by |
| | weight) | weight) | weight) | weight) |
| Component C | PERHEXA V | PERHEXA V | PERHEXA V | — |
| | (2 parts by | (2 parts by | (2 parts by | |
| | weight) | weight) | weight) | |
| Tg | 100° C. | 105° C. | — | — |
| T_{d5} | 360° C. | 310° C. | 253° C. | — |
| Ea | — | 83 kJ/mol | — | — |

From these results, it was shown that the composition of the invention shows high heat resistance even in a low-temperature process.

### EXAMPLE 14

An enamel wire EIW-A 1 mm in diameter manufactured by Hitachi Magnet Wire was formed into a helical coil having an inner diameter of 5 mm and a length of 7.5 cm as described in JIS C 2103, Appendix 3, and used as an enamel wire coil.

The produced coil was impregnated with the varnish shown in Example 5 for 5 minutes and then cured at 120° C. for 60 minutes. Subsequently, the coil was turned upside down, impregnated with the varnish shown in Example 1 for 5 minutes, and then cured at 120° C. for 60 minutes. The obtained coil was subjected to a bending fracture test at 23° C. using an autograph DSS-500 manufactured by Shimadzu. In the bending test, the distance between the supports was 44 mm, and the crosshead speed was 0.5 mm/min. A load was applied to the center of a specimen, and the load at break was defined as adhesion strength. In the test, five specimens were used, and their average was determined. The obtained adhesion strength was 120 N.

### COMPARATIVE EXAMPLE 5

Enamel wires EIW-A and AIW 1 mm in diameter manufactured by Hitachi Magnet Wire were formed into a helical coil having an inner diameter of 5 mm and a length of 7.5 cm as in JIS C 2103, Appendix 3, and used as an enamel wire coil.

The produced coil was impregnated with the varnish shown in Comparative Example 2 for 5 minutes and then cured at 80° C. for 30 minutes. Subsequently, the coil was turned upside down, impregnated with the varnish shown in Comparative Example 1 for 5 minutes, and then cured at 1300° C. for 60 minutes. The obtained coil was evaluated for adhesion strength in the same manner as in Example 14. The obtained adhesion strength was 100 N.

### EXAMPLE 15

A stator including a coil produced by winding an enamel wire 1 mm in diameter around a winding core was impregnated with the thermosetting resin composition shown in Example 5. The resin was then cured by heating in a warm-air circulation thermostat preheated to 120° C. for 60 minutes to give a stator having a fixed coil. The stator showed the same insulating characteristics as a motor using an insulated stator obtained by impregnation with the thermosetting resin composition shown in Comparative Example 2, followed by curing at 130° C. for 2.0 hours.

### EXAMPLE 16

Two hundred parts by weight of spherical silica fine particles were mixed with 100 parts by weight of the thermosetting resin composition shown in Example 5 to give a resin for molding. Using the resin, the helical coil used in Example 14 was molded. Curing conditions were as follows: maintenance at 100° C. for 2 hours, followed by treatment at 120° C. for 2 hours. The molded article showed better thermal weight loss characteristics as compared with a specimen obtained by molding an enamel wire with a mixture of 100 parts by weight of the thermosetting resin composition shown in Comparative Example 2 and 200 parts by weight of spherical silica fine particles.

What is claimed is:

1. A thermosetting resin composition comprising:
(A) a compound of an oligomer having two or more of radical-polymerizable substituent X of which binding energy of repeated structure is higher than binding energy of carbon-carbon formed by the substituent X;
(B) a compound having a polymerizable substituent highly reactive with the substituent X; and
(C) a polymerization initiator.

2. The thermosetting resin composition according to claim 1, wherein the substituent X in the component (A) is styryl group.

3. The thermosetting resin composition according to claim 1, wherein the compound of the component (B) is represented by Formula 2: 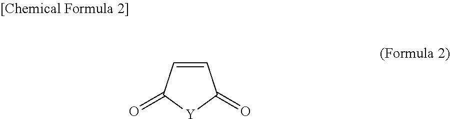
wherein the substituent Y is a nitrogen atom having an oxygen atom, a sulfur atom, or a substituted thereof.

4. The thermosetting resin composition according to claim 1, wherein the polymerization initiator of the component (C) is peroxide, an organic azo compound, a boron compound represented by Formula 3: 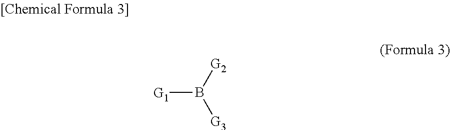
wherein each of G₁, G₂, and G₃ is independently R₁ or OR₁ wherein at least one of G₁, G₂, and G₃ is R₁, and R₁ is hydrogen, alkyl group, cycloalkyl group, aralkyl group, or aryl group, or alkoxylamine represented by Formula 4: 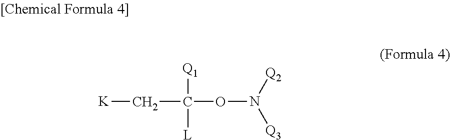
wherein Q₂ is hydrogen or alkyl group, each of Q₃ and Q₄ is independently alkyl group, cycloalkyl group, or alkylene group, L is alkyl group, cycloalkyl group, aryl group, or alkoxycarbonyl group, and K is alkyl group, cycloalkyl group, aryl group, alkoxyl group, or acyloxy group.

5. The thermosetting resin composition according to claim 1, wherein a molecular weight of the compound of the component (A) is 1000 or more.

6. The thermosetting resin composition according to claim 1, wherein a glass transition temperature of the compound of the component (A) is 100° C. or more.

7. A thermosetting resin composition, comprising (D) an amount of 100 or more parts by weight of inorganic fine particles in 100 parts by weight of the resin composition of claim 1.

8. A cured material obtainable by heating the thermosetting resin composition of claim 1.

9. The cured material according to claim 8 of which a 5% weight loss temperature is 360° C. or more.

10. The cured material according to claim 8 of which activation energy is 100 kJ/mol or more at the time of thermal decomposition.

11. A conductive wire insulated with the cured material of claim 8.

12. A coil for an electrical device comprising the conductive wire of claim 11 and a magnetic core.

13. An electrical device comprising the coil for an electrical device according to claim 12.
